(19) United States
(12) Patent Application Publication
(10) Pub. No.: US 2023/0320292 A1
(43) Pub. Date: Oct. 12, 2023

(54) DRIP IRRIGATION DEVICE

(71) Applicant: METZERPLAS COOPERATIVE AGRICULTURAL ORGANIZATION LTD., M.P. Heffer (IL)

(72) Inventors: Alexander GELLER, Haifa (IL); Yitzhak ROTEM, M.P. Heffer (IL)

(21) Appl. No.: 18/044,298

(22) PCT Filed: Aug. 19, 2021
(86) PCT No.: PCT/IL2021/051013

§ 371 Date: Mar. 7, 2023

(30) Foreign Application Priority Data
Sep. 10, 2020 (IL) 277282

(51) Int. Cl. A01G 25/02

(52) U.S. Cl. CPC A01G 25/023

(57) ABSTRACT

A drip irrigation device for integration within an irrigation pipe comprises a first face and a second face symmetrical to each other, and a central depressed accumulator.

### CROSS-REFERENCE TO RELATED APPLICATIONS

This application is a National Phase Entry of PCT/IL2021/051013, filed Aug. 19, 2021 which claims priority to and the benefit of Israel Application No. 277282, filed Sep. 10, 2020, the disclosures of which are incorporated herein by reference in their entirety.

### FIELD OF THE INVENTION

The present invention relates to the field of drip irrigation. More particularly, the invention relates to a drip irrigation device that can be integrated with an irrigation pipe.

### BACKGROUND OF THE INVENTION

For decades, drip irrigation has proven to be a cost-effective, and growth-effective irrigation means for mass agriculture and horticulture. Various external dripping devices have been offered on the market for decades and are still widely used, particularly in horticulture applications. The deployment of irrigation piping followed by the installation of external dripping devices consumes significant time and effort, and the resulting dripping piping is highly sensitive to the proper pipe puncturing (e.g., avoiding too large or too small hole size, which results in leakage), proper dripper insertion (e.g., applying the required insertion force to properly insert a dripper's inlet into the punctured hole, yet not too high a force which may damage the hole margins, resulting in leakage). Furthermore, external drippers are prone to leakage under too low or too high irrigation pressures and susceptible to clogging matter such as sand grains.

FIG. 1 schematically illustrates a type of drip irrigation solution offered on the market, which is essentially a flat device 1 embedded into an irrigation pipe (not shown) during its manufacturing process, wherein device 1 comprises various flow channels 2 between an inward face (i.e., facing the irrigation pipe cavity) to its outward face (that is made to adhere to the internal wall of an irrigation pipe) which commonly comprises a depressed accumulator 3, into which irrigation fluid flows from the various flow channels, and accumulates before being released through a corresponding dripping hole, which is punctured through the pipe during manufacturing.

A commonly required manufacturing step of device 1 is validating the longitudinal orientation of accumulator 3 before it is embedded into the irrigation pipe for verifying that depressed accumulator 3 is currently located below the planned piercing point of the irrigation pipe. This step is essential for avoiding manufacturing faults where device 1 is oppositely oriented prior to being embedded into the irrigation pipe, and hence the pipe piercing is not aligned with depressed accumulator 3, resulting in a non-dripping or an unregulated dripping point. The validation step and, where needed, the re-orientation of opposite-oriented devices 1 incur significant manufacturing costs. Another essential validation step is verifying that device 1 is currently oriented with its outer face towards the internal wall of an irrigation pipe prior to its adhesion thereto.

Furthermore, many existing flat drippers are adapted with too small filtration areas having too few flow passages (between the inward and outward faces), resulting in limited flow capacity and susceptibility to clogging matter.

It is an object of the present invention to provide a drip irrigation device that is insensitive to its orientation during its integration into an irrigation pipe.

It is another object of the present invention to provide a drip irrigation device adapted with adequate filtration passages, thereby being less susceptible to clogging matter and ensuring a desirable irrigation flow.

Yet another object of the present invention is to provide a drip irrigation device designed with the minimum required components, thus enabling low manufacturing costs.

Other objects and advantages of the invention will become apparent as the description proceeds.

### SUMMARY OF THE INVENTION

The invention relates to a drip irrigation device for integration within an irrigation pipe, comprising a first face and a second face symmetrical to each other and a central depressed accumulator.

The term “symmetrical,” as used herein, means that regardless of which face adheres to the pipe wall, the outward-facing face will always have the accumulator located centrally.

According to an embodiment of the invention, each of said first face and second face has a filtration area comprising a plurality of flow passages defined by horizontal and vertical intermediate ribs.

In another embodiment of the invention, the device further comprises a flow channel suitable to enable the regulated flow of irrigation liquid from within said irrigation pipe through said flow passages into the central depressed accumulator. Such flow channels are well known in the art and, therefore, are not described herein in detail for the sake of brevity.

According to yet another embodiment of the invention, the device of the invention may comprise raised margins adapted to provide an adhesion surface of said first face to the inner wall of said irrigation pipe, while said second face faces the internal cavity of said irrigation pipe.

The invention provides, with the symmetrical shape of the first face and of the second face, an arrangement such that, together with the central position of the depressed accumulator, it enables a dripping hole to be punctured in the irrigation pipe at a location facing the depressed accumulator, regardless of which face is orientated outwards and regardless of the longitudinal orientation of said drip irrigation device during the manufacturing process.

In one embodiment of the, the device can be provided with reduced portions created during the manufacturing process, thereby reducing the amount of plastic material used.

### BRIEF DESCRIPTION OF THE DRAWINGS

FIG. 1 schematically illustrates an essentially flat irrigation device of the known art;

FIG. 2A schematically illustrates drip irrigation devices, integrated into an irrigation pipe, during the piercing manufacturing step of the irrigation pipe, according to an embodiment of the present invention;

FIG. 2B shows a sectional view of an irrigation pipe with an integrated drip irrigation device, according to an embodiment of the present invention;

FIG. 3A is a rear perspective view showing an inward face of a drip irrigation device, according to an embodiment of the present invention; and

FIG. 3B is a front perspective view showing an outward face of the drip irrigation device of FIG. 3A.

The terms “inward” and “outward” are used herein to indicate the positioning of one of the symmetric faces relative to the inner wall of the irrigation pipe.

### DETAILED DESCRIPTION

The present invention relates to a drip irrigation device suitable to be integrated within an irrigation pipe in such a manner that one (outward) face of the proposed device adheres to the internal wall of the irrigation pipe, and the proposed device is adapted to receive a desirably pressurized irrigation liquid within the irrigation pipe, and to enable the release the of the irrigation liquid in a regulated manner, through a dripping hole.

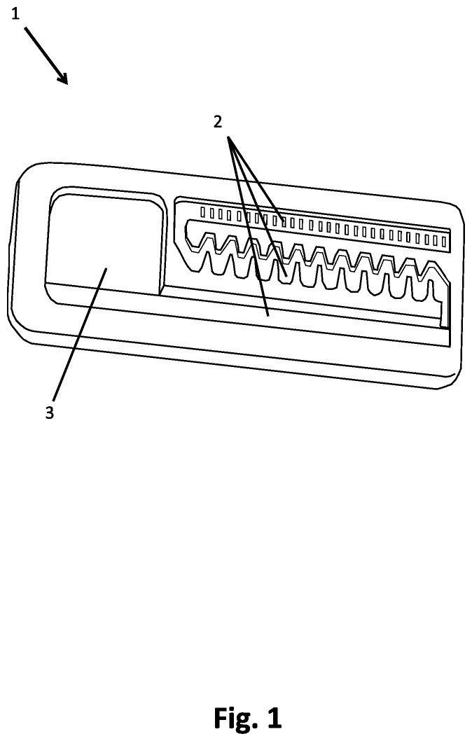

FIG. 1 shows a conventional dripper. This device, as explained, requires an orientation step during integration in a dripping line to orientate accumulator 3 such that it is correctly positioned in the dripping line and/or suffers the danger that some drippers within the dripping line be disoriented and hence, non-operative. Moreover, this device comprises relatively narrow passages between inward and outward faces thereof.

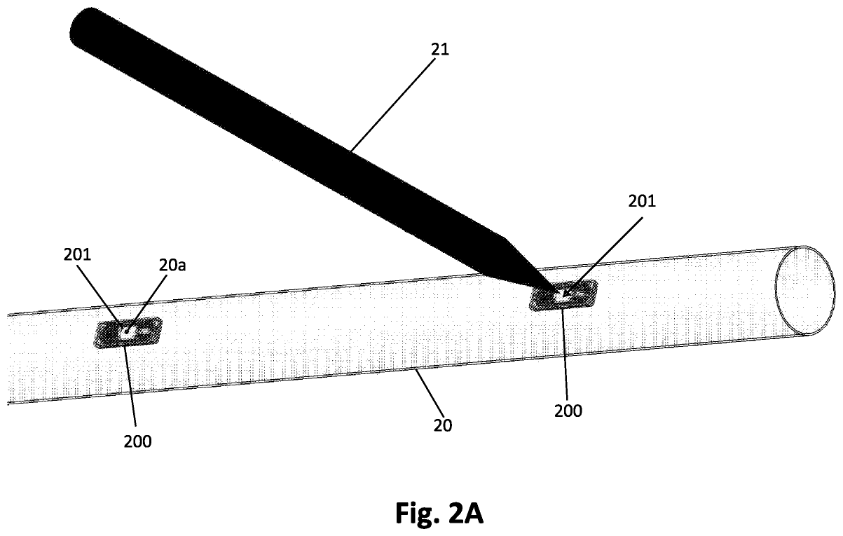

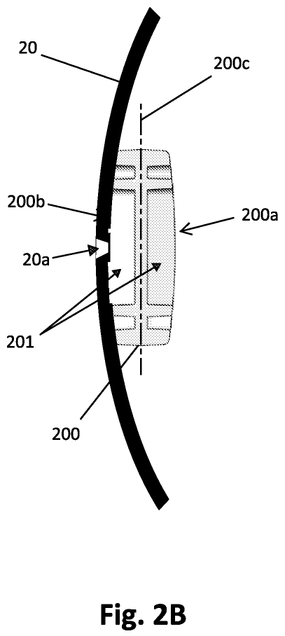

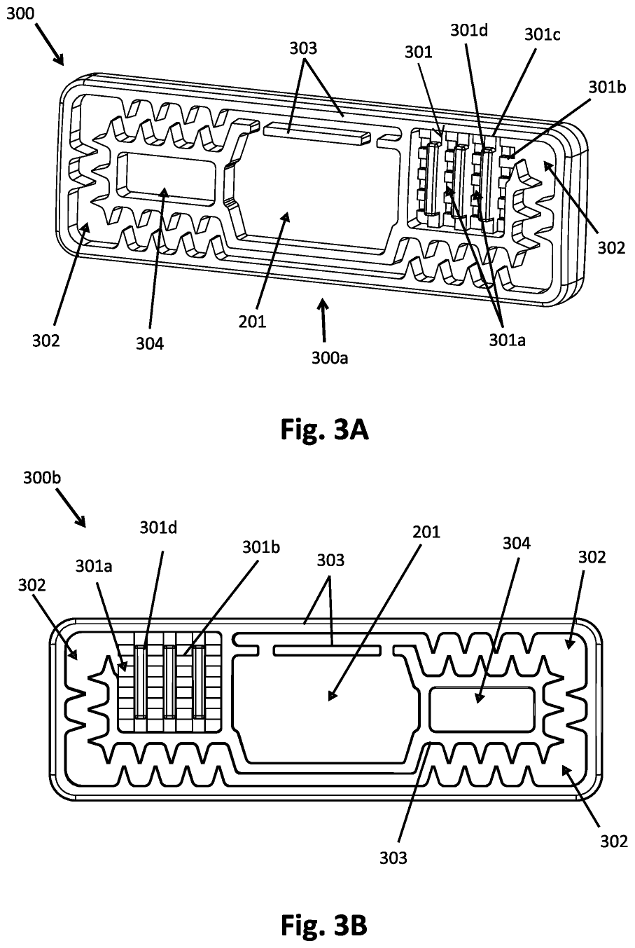

FIG. 2A shows drip irrigation devices 200 integrated into an irrigation pipe 20 (also referred to herein as “dripping line”), shown as transparent for the sake of illustration, during the piercing manufacturing step in which pipe 20 is perforated by piercing device 21, according to an embodiment of the present invention. The illustrated section of pipe 20 comprises two irrigation devices 200, each of which comprises a depressed accumulator 201 (further illustrated in FIG. 3B), symmetrically positioned with respect to the center of devices 200. According to the invention, the central location of depressed accumulator 201 (i.e., at the center of device 200) enables a punctured dripping hole 20a created in pipe 20 to face depressed accumulator 201 regardless of the longitudinal orientation of device 200 (i.e., during the manufacturing process of irrigation pipe 20), at which device 200 is embedded into pipe 20. Therefore, the device of the invention eliminates the need for an orientation validation step during the manufacturing of irrigation pipe 20. Moreover, the substantial perimeter of depressed accumulator 201 (with respect to the overall size of device 200) enables lower puncturing precision requirements or fewer manufactured drippers wasted due to intermittent machine accuracy faults.

FIG. 2B shows a section view of pipe 20 with an integrated drip irrigation device 200, according to an embodiment of the present invention, wherein device 200 comprises an inward face 200a, which faces the cavity of pipe 20, and an outward-facing face 200b, which adheres to the internal wall of pipe 20, with depressed accumulator 201 of device 200 faces dripping hole 20a.

FIG. 2B further shows symmetrical faces 200a & 200b with respect to dashed line 200c representing the mid plan of device 200, thus illustrating that even if face 200a would have adhered to pipe 20 (i.e., instead of face 200b), dripping hole 20a would still be facing depressed accumulator 201. Moreover, the simple and symmetrical design of device 200 enables a relatively cost-effective manufacturing process of device 200.

FIG. 3A is a rear perspective view showing an inward face of a drip irrigation device, according to an embodiment of the present invention, in which an inward face 300a of device 300 comprises a filtration area 301 with a plurality of flow passages 301a, defined by horizontal and vertical intermediating ribs 301b and 301c (correspondingly), having raised portions 301d. Irrigation liquid in pipe 20 flows through passages 301a to an outward-facing face 300b (shown in FIG. 3B), while intermediate ribs 301b and 301c function as filtration means for preventing undesired foreign bodies, such as sand grains, from flowing through passages 301a.

Inward face 300a further comprises a regulation flow channel 302, depressed accumulator 201 (described in detail with reference to FIG. 3B).

FIG. 3B is a front perspective view showing an outward face of the device of FIG. 3A, in which irrigation liquid flowing through passages 301a further flows through channel 302 into depressed accumulator 201, facing dripping hole 20a of FIGS. 2A-2B, through with it is discharged.

Further shown in FIGS. 3A-3B are raised margins 303 and reduced portions 304, wherein raised margins 303 and raised portions 301d are adapted to support the structure of device 300 while providing sufficient adhesion surface for adhesion of the device to pipe 20 and ensuring an exclusive flow of irrigation liquid through passages 301a, channel 302, accumulator 201 and into dripping hole 20a. Reduced portions 304 are created during the manufacturing process of device 300 for reducing the amount of used plastic material.

Although embodiments of the invention have been described by way of illustration, it will be understood that the invention may be carried out with many variations, modifications, and adaptations, without exceeding the scope of the claims.

1. A drip irrigation device for integration within an irrigation pipe, comprising a first face and a second face symmetrical to each other, and a central depressed accumulator.

2. The device of claim 1, wherein each of said first face and second face has a filtration area comprising a plurality of flow passages defined by horizontal and vertical intermediate ribs.

3. The device of claim 1, further comprising a flow channel suitable to enable the regulated flow of irrigation liquid from within said irrigation pipe through said flow passages into the central depressed accumulator.

4. The device of claim 1, further comprising raised margins adapted to provide an adhesion surface of said first face to the inner wall of said irrigation pipe, while said second face faces the internal cavity of said irrigation pipe.

5. The device of claim 1, wherein the symmetrical shape of the first face and the second face is provided such that, together with the central position of the depressed accumulator, it enables a dripping hole to be punctured in the irrigation pipe at a location facing the depressed accumulator, regardless of which face is oriented outwards and regardless of the longitudinal orientation of said drip irrigation device during the manufacturing process.

6. The device of claim 1, provided with reduced portions created during the manufacturing process of said device, thereby reducing the amount of plastic material thereof.
